(19) United States
(12) Patent Application Publication
(10) Pub. No.: US 2006/0231688 A1
(43) Pub. Date: Oct. 19, 2006

(54) Mounting Block for Two Objects to be Securely Attached to Each Other at Any Angle

(75) Inventor: Dominick Joseph Minneci JR., Whiting, NJ (US)

Correspondence Address: DOMINICK J. MINNECI JR., 1380 BROOKLYN AVENUE, WHITING, NJ, 08759, US

(73) Assignee: Mr. Dominick Joseph Minneci JR., Whiting, NJ (US)

(21) Appl. No.: 10/907,715

(22) Filed: Apr. 13, 2005

(51) Int. Cl. F16L 3/00

(52) U.S. Cl. 248/62

(57) ABSTRACT

The Mounting Block for Two Objects to be Securely Attached to Each Other at Any Angle (Mounting Block) is a two-piece device for the purposes of attaching, installing, affixing or mounting two objects to each other at any angle, specifically for attaching a pipe, conduit, round or curved object or structure to another pipe, conduit, round or curved object or structure; however, the objects can be of any shape. Each piece of the Mounting Block has two sides and a top. The tops of each piece can be a flat or curved with slots and/or holes in which they can be mated together and rotated relative to each other. Bolts inserted through the holes and/or slots, when tightened, lock the two pieces in place. The sides of each piece are slotted to facilitate strapping or clamping objects to the Mounting Block. The pieces of the Mounting Block can be interchanged with other pieces of various size to facilitate the mounting of various diameter round objects.

This invention generally relates to the mounting of a round object to another round object when the two objects must be at a specific angle relative to each other.

### BACKGROUND OF INVENTION

1. Field of the Invention

The present invention generally relates to the installation of conduits and pipes to round objects or structures, such as the installation if a conduit or pipe to another conduit or pipe, or the installation of conduit or pipe to a round structure, like a sign post. The device can essentially be used to mount any two objects to each other at any angle.

2. Current Practice

Currently, when two round objects are connected to each other, such as when a conduit is being connected to a round post, the conduit is placed directly up against the post and a simple band strap is tightened around them. For instances where a single pipe is parallel to a post, this method is sometimes sufficient, but when strapping the conduit at any other angle to the post, or when strapping multiple conduits to the post, it can be extremely difficult; the objects can not be securely attached because the as the strap is tightened it tries to bring then into alignment, which puts unwanted stresses on the conduit and the post.

This is the current practice because there is no simple device for mounting the two objects to each other. It requires the use of other devices or an apparatus consisting of multiple bolts, U-bolts, clamps, struts and/or other hangers. Furthermore, it is difficult to perform the task efficiently and effectively with a single person because it involves several steps using multiple tools.

### BRIEF DESCRIPTION OF DRAWINGS

FIG. 1 is a front, top, and side view of the device made in accordance with the claims of the present invention;

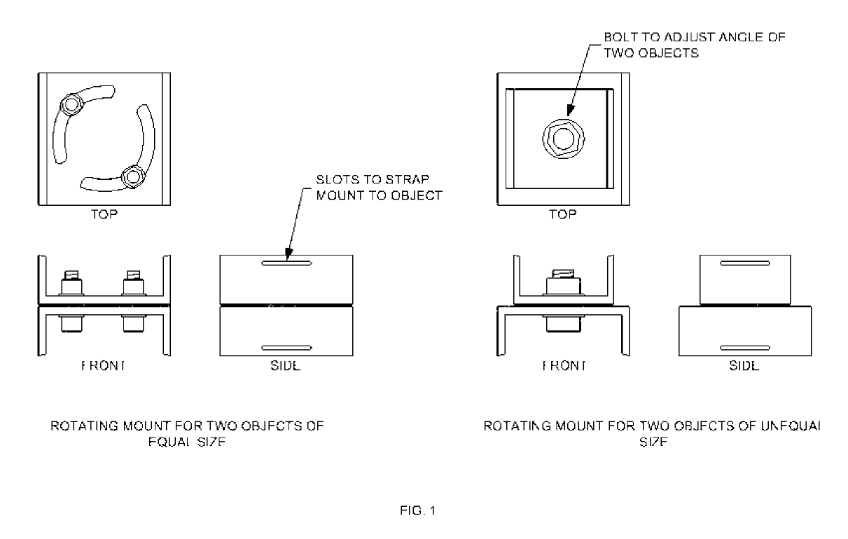

FIG. 2 is an example installation of the invention being used to connect a round object to another round object at a 45 degree angle.

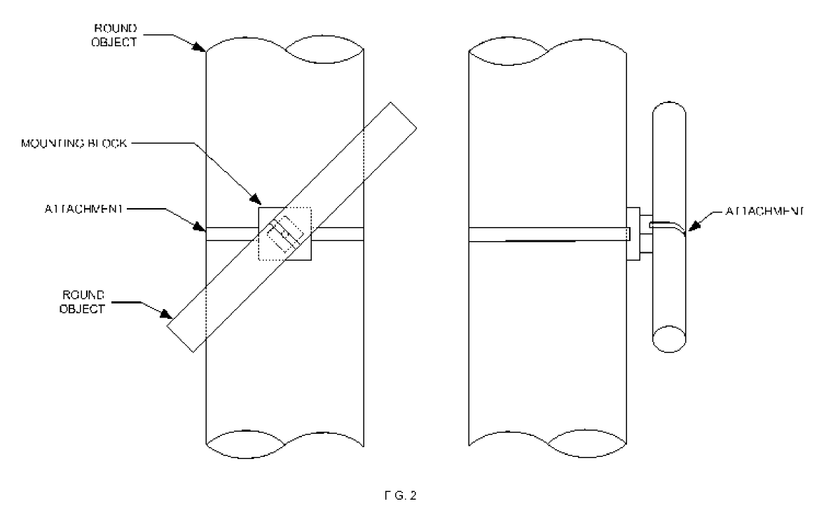

### DETAILED DESCRIPTION

This invention overcomes the deficiencies of the current practice by allowing the two round objects to be attached to each other securely and in perfect alignment, at any angle to each other, by a single person with very few tools. To use an example, say a conduit is to be attached to a post—the device would be attached to the post, the adjusting bolt tightened to the proper angle, and the conduit could then be attached to the post.

This invention also provides for some flexibility when two round objects do not perfectly align with each other. The bolt can be loosened and the two halves of the mount can be realigned to provide a mount that can accommodate the angle.

Each half of this invention can be manufactured individually and appropriately sized halves can be quickly and easily combined in any combination to facilitate the attachment of two round objects of any size.

This invention allows for easy interchange of the two halves by loosening and removing a nut(s) on a bolt(s) through the middle of the two halves to allow changing of the size of the round objects.

What is claimed is:

1. A device,
comprised of a two pieces;
in which each piece has two sides and a top;
where the sides can rest securely against a round object and be affixed to the object by means of a clamp or strap placed through slots in each side;
where the top can fit securely against the top of a similar piece and can be bolted at any angle relative to that piece by a bolt or multiple bolts through holes or slots in the top of the piece.

2. Device in claim 1, to be used for connecting, installing, affixing or mounting two pipes, conduits, round or curved objects or structures at any angle to each other.
